(19) United States
(12) Patent Application Publication
(10) Pub. No.: US 2026/0285089 A1
(43) Pub. Date: Sep. 24, 2026

(54) NON-PNEUMATIC TIRE AND WHEEL WITH TENSIONED SPOKE ELEMENTS

(71) Applicant: Abraham Pannikottu, Akron, OH (US)

(72) Inventor: Abraham Pannikottu, Akron, OH (US)

(21) Appl. No.: 19/082,354

(22) Filed: Mar. 18, 2025

(51) Int. Cl. B60C 7/14

(52) U.S. Cl. CPC B60C 7/146

(57) ABSTRACT

The combination of a non-pneumatic tire and wheel has an outer annular wheel assembly, consisting of first and second outer wheel sections, and an inner hub assembly for attachment to a vehicle. The outer annular wheel assembly and inner hub assembly have axially and radially uniformly positioned connectors or hooks thereabout. A second plurality of elastomeric spokes are interposed between paired connectors of the outer annular wheel assembly and inner hub assembly in tensioned engagement. The elastomeric spokes extend between paired hooks or connectors in either a radial pattern or a crisscross lace pattern.

### TECHNICAL FIELD

The invention herein resides in the art of wheel and tire assemblies. More particularly, the invention relates to non-pneumatic tires designed to support loads without the use of air-filled tires having sidewalls capable of receiving and distributing a load, with the sidewalls providing a cushioning effect. More particularly, the invention relates to the implementation of a non-pneumatic tire that employs elastomeric spokes interposed between inner and outer annular rings, the inner ring receiving and supporting the load by a cushioning effect achieved through changes in tensioning of the elastomeric spokes during rotation of the wheel.

### BACKGROUND OF THE INVENTION

Traditionally, most tires are pneumatic, being filled with air maintained between the tire body and a hub assembly. Such tires are given to failure by air leakage, giving rise to the advent and implementation of “run-flat” tires that include structures for allowing continued operation in the event of even a total loss of air pressure.

In the past, non-pneumatic or airless tires have primarily been constructed from solid materials. While durable, these solid tires provide a less comfortable ride for passengers and increased wear on a vehicle's suspension system, which had to compensate for the tire's lack of flexibility. The introduction of pressurized air in tires improves the ride comfort significantly, but such pneumatic tires have the drawback of requiring additional structure to accommodate run-flat operation.

It has also been noted that the material incasing standard pneumatic tires is prone to air leakage over time. This can occur both around the wheel rim and, more subtly as oxygen if absorbed through the rubber itself. As the tire loses pressure, it flattens in the area where the load is applied, increasing the portion of the tire that bears the load with each revolution. This accelerates wear and tear on the tire. Additionally, pneumatic tires are vulnerable to punctures, causing rapid loss of air pressure, and comprising the tire's performance and safety.

To enhance fuel efficiency, safety and ride comfort, efforts have been made in the past to address the limitations of pneumatic tires, while preserving other advantages over solid non-pneumatic options. It has been known to integrate the tire and wheel into a single unit composed of four main components—a wheel, bendable spokes, a reinforced annular band surrounding the compressible buckling spokes, and a rubber tread that contacts the ground. Other attempts have included making solid tires out of polyurethane instead of rubber and suspending reinforcement materials within the polyurethane during molding. Additionally, internal ribs made of a thermoplastic reinforced with fiberglass have also been employed. Yet additionally, it has been known to even use electroactive polymer that is capable of changing shape when an electrical current is applied, allowing the tire to change shape or size based on road conditions by using the automobile's electrical system.

The known art of non-pneumatic wheel and tire assembly have been incapable of providing the comfort, “ride,” maneuverability, and operative response of pneumatic tires. Previously, wheeled vehicles have been unable to enjoy the benefits of pneumatic tire and wheel assemblies while still enjoying the “run-flat” capabilities of non-pneumatic tire and wheel assemblies.

### DISCLOSURE OF INVENTION

In light of the foregoing, it is a primary aspect of the invention to provide a non-pneumatic wheel and tire assembly that significantly replicates the performance, handling, comfort, “ride,” and performance of a pneumatic tire, without the attendant issues of losing such benefits due to reduction or loss of air pressure.

The foregoing and other aspects of the invention that will become apparent herein are achieved by a non-pneumatic tire and wheel, comprising: an outer annular wheel assembly; an inner hub assembly for attachment to an axle of a vehicle; and a plurality of elastic spokes in tensioned interconnection between said outer annular wheel assembly and said inner hub assembly.

Other aspects of the invention that will become apparent herein are achieved by a non-pneumatic tire and wheel, comprising: an outer annular wheel assembly comprising first and second outer wheel sections; an inner hub assembly for attachment to a vehicle; said outer annular wheel assembly and inner hub assembly being characterized by axially and radially uniformly positioned connectors; and a plurality of elastomeric spokes in tensional engagement between paired connectors of said outer annular wheel assembly and inner hub assembly.

### BRIEF DESCRIPTION OF THE DRAWINGS

For a complete understanding of the various aspects, structures, and method of the invention, reference should be made to the following detailed description and accompanying drawings, wherein:

FIG. 1 is a perspective view of a non-pneumatic tire with tensioned spoke elements made in accordance with the invention;

FIG. 2 is an assembly drawing of the non-pneumatic tire assembly of FIG. 1;

FIG. 3 is a perspective view of the inner hub assembly of the non-pneumatic tire of FIGS. 1 and 2;

FIG. 4 is a perspective view of a rubber or elastic spoke for interconnection between an outer wheel assembly and an inner hub assembly of the invention;

FIG. 5 is a front elevational view of an illustrative embodiment of the invention wherein the spokes are undeformed;

FIG. 6 is a front elevational view of the illustrative embodiment FIG. 5, wherein the spokes are deformed by stretching to 20% tensile elongation; and

FIG. 7 is a front elevational view of the illustrative embodiment of FIGS. 5 and 6, wherein the spokes are deformed to a 40% tensile elongation.

### DETAILED DESCRIPTION OF PREFERRED EMBODIMENTS

In general, the invention consists of enough of a ring-shaped outer wheel assembly that is coated with a tread and an inner hub assembly for mounting to the axle/suspension of a vehicle. The outer wheel assembly is radially bifurcated into two mating sections. The outer wheel assembly and the inner hub assembly are interconnected by tension spokes of rubber, polymer, or other suitable material with significant elasticity. The radially bifurcated mating sections of the outer wheel assembly may be rotated with respect to each other and with respect to the hub assembly to pretension the tension spokes, such spokes remaining in tension throughout their life of operation.

The design of the spokes and their lacing pattern between the bifurcated sections of the wheel assembly and the sub assembly in the resulting airless tire wheel is important in determining the static and dynamic stability of the wheel. In this invention, the tension spokes play a pivotal role in efficiently transferring driving torque from the hub to the rim or outer wheel assembly, which is essential for optimal performance. The primary airless wheel features a dual wheel-indexing mechanism that supports a tensioned spoke system, which incorporates a mix of lateral, tangential, and radial spoke angular orientations to achieve maximum stability and efficiency. The spokes are pre-strained to 20-80% of their original length to support the vehicle load under both static and dynamic conditions, while also significantly enhancing the durability and extending the useful life of the spokes.

Multiple spokes on each side of the wheel work together to replicate the functionality typically provided by air in a pneumatic tire. Radial spokes are arranged in a straight line from the hub to the rim and manage radial loads, making them suitable for lightweight applications where side forces are minimal. Tangential spokes, which are angled and cross other spokes, are responsible for efficiently transferring torque and handling rotational forces, making them ideal for driven wheels and those subjected to braking forces. Lateral spokes, though less commonly referenced, contribute to the wheel's resistance against side loads, helping to maintain alignment and prevent lateral wobble. A re-treadable rubber tread on the dual wheel's circumference comes into contact with the road or ground. As the tire is used, the pre-cured tread gradually wears down, reducing its ability to provide traction.

In torque transfer systems, tangentially laced spokes are essential. Spokes leaving the hub at angles transmit torque through a balance of leading and trailing spokes, which counteract each other during both acceleration and braking. This symmetry ensures that the wheel remains true and stable under varying torque conditions. Wheels that do not require significant torque transfer may use radial lacing, but a mix of radial and tangential patterns can be implemented, particularly for wheels requiring both torque transfer and lateral stability. Stretchable elastomeric tension spokes are designed with braided flexible carbon or nylon fiber sleeve to avoid over stretching.

The tension-spoke airless tire wheel gains its stiffness and strength from the synergistic relationship between the wheel and the spokes. The dual wheel provides the spokes pre-tension, preventing buckling under external loads, while the spokes transfer external forces to the hub, preserving the rim's structural integrity. This pre-stressed spoke design allows the airless tire to handle various forces and moments, including normal force, friction forces (both longitudinal and lateral), braking, traction, centripetal forces, and several key moments such as yaw, camber, and self-aligning torque. These interactions between forces and moments dictate the subject airless tire's overall performance, enhancing its handling, braking, traction, and stability capabilities.

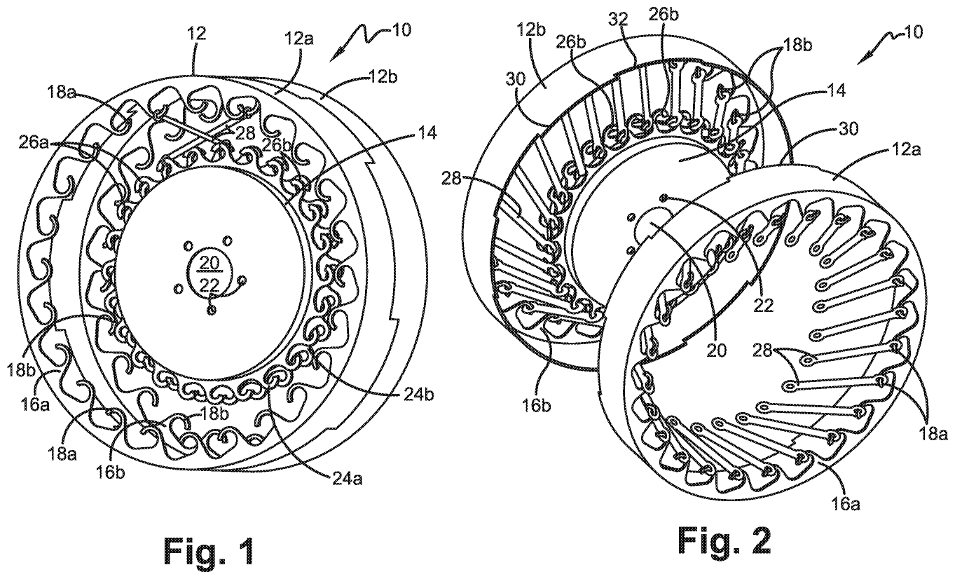

Referring now to the drawings, and more particularly FIGS. 1 and 2, it can be seen that a non-pneumatic tire and wheel with tensioned spoke elements is designated generally by the numeral 10. As shown, an outer annular wheel assembly 12 receives an inner hub assembly 14. As will be discussed later, the outer annular wheel assembly 12 comprises a pair of outer wheel sections 12a, 12b, which are positionally adjustable with respect to each other and which can be nested together to form the unitary outer annular wheel assembly 12, as will be discussed further below.

A pair of hook flanges 16a, 16b respectively characterize the edges of outer wheel sections 12a, 12b, as by appropriate fixation such as welding, or the like. Each of the hook flanges 16 has a series of uniformly circumferentially spaced connectors or hooks 18a, 18b, as shown.

The inner hub assembly 14 provides a receiving aperture 20 for receipt of a vehicle axle mounted thereto by bolts or the like passing through the mounting holes 22. Of course, the axle is a part of the vehicle suspension, accommodating movement between the vehicle and the wheel.

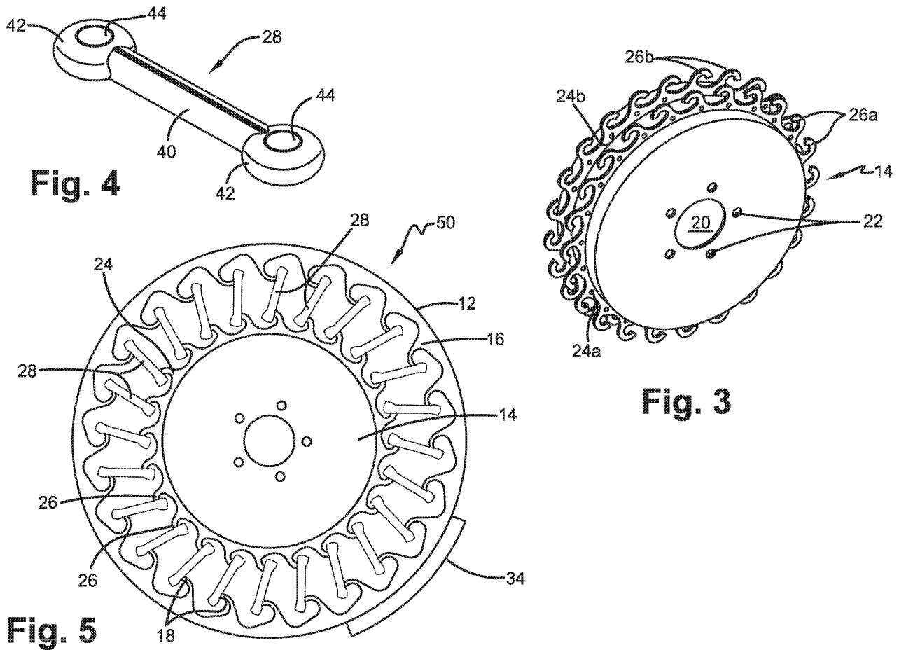

As shown in FIG. 3, the inner hub assembly 14 has hub hook rings 24a, 24b mounted thereto as by weldments or the like. The hub hook rings 24a, 24b respectively have uniformly circumferentially spaced connectors or hooks 26a, 26b thereabout. It will be appreciated that the hub hook rings 24a, 24b are uniformly spaced from and parallel to each other. In the embodiment shown, the ring 24b is positioned at an inner edge of the inner hub assembly 14, with the ring 24a being positioned nearer the center. It will similarly be appreciated that the hook flanges 16a, 16b are parallel to and spaced from each other. In the final assembly, as shown in FIG. 1 a preferred embodiment has the hub hook rings 24a, 24b, uniformly positioned between the hook flanges 16a, 16b, although that position may be different to fine tune the non-pneumatic tire and wheel assembly 10 for a particular vehicle or implementation.

With continued reference to FIGS. 1 and 2, it can been seen that rubber spokes 28, of rubber or other suitable elastomeric material, are interconnected between the hooks 18 of the hook flanges 16 and the hook 26 of the hub hook rings 24. The spokes 28 provide the load-bearing function for the associated vehicle, the axle of which is retained by the inner nub assembly 14. It will be appreciated that the spokes 28 provide for interconnection between the hooks 26 of the hub hook rings 24 and the hooks 18 of the hook flanges 16 circumferentially about both the hub assembly 14 and the outer annular wheel assembly 12.

A representative embodiment of the spokes 28 is shown in FIG. 4. Spokes 28 are of a rubber or other suitable elastomeric material with the tensile strength to accommodate vehicle loads with the extension range of the spoke operating below 25% of its maximum extension. It has been found that operations within this range accommodate a near infinite life for the spokes without fatigue or braking. As shown, the spokes 20 have an elongated body 40 with an annular disc 42 at each end thereof, resulting in a dog-bone configuration. Of course, any of various configurations can be employed. In the embodiment shown, a metal sleeve is received within the annular discs as shown, a metal sleeve 44 is received within the annular discs as shown. The metal sleeves receive the hooks 18 of the hook flanges 16 and the hooks 26 of the hub hook rings 24.

With reference again to FIGS. 1 and 2, it will be noted that the inner edges of the outer wheel sections 12a, 12b are characterized by alternating tabs 30 and detents 32. As best shown in FIG. 1, these tabs and detents are configured for mating engagement with each other, which are held together by the tension of the spokes 28. It will be further appreciated that the tension of the spokes can be set by the indexing of the outer wheel sections 12a, 12b with respect to each other. This tensioning can be achieved by axially separating the outer wheel sections 12a, 12b and then rotating them in opposite directions a distance that will accommodate a next mating engagement between the tabs 30 and detents 32, with a resultant stretching and tensioning of the spokes 28. The size of the tabs 30 and detents 32 controls the degree to which such indexing can occur, it being recalled that it is desired that the spokes 28 are never stretched beyond 25% of their maximum extension when in operation.

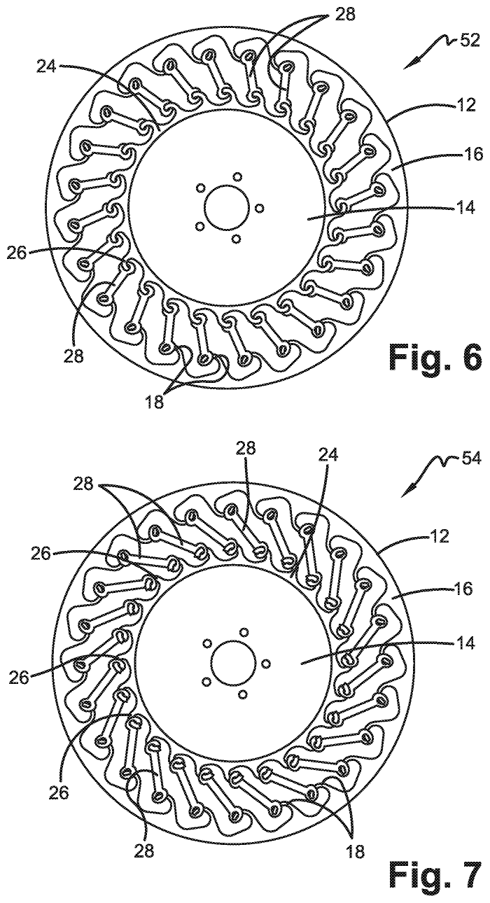

FIGS. 5-7 present an illustrational embodiment of the invention showing the spokes 28 interconnected between hub hooks 28 and outer wheel assembly hooks 18. In FIG. 5, the outer wheel sections 12a, 12b are in their initial assembly positions such that the hooks 18 of the hook flanges 16 are most closely aligned with the hooks 26 of the hub hook ring 24, such that the spokes 28 can ben interconnected therebetween quite readily. After such positioning of the spokes 28, the outer wheel sections 12a, 12b may be separated and indexed to a next position where the tabs 30 and detents 32 can be mated. As shown in FIG. 6, this index is at a 20% tensile elongation. From there, the outer wheel sections 12a, 12b can be separated and indexed further as shown in FIG. 7, where the rubber spokes 28 are extended to a 40% tensile elongation. Rubber spokes typically exhibit an ultimate elongation of over 400%. Based on fatigue theory, limiting the elongation to 100% or less can result in an infinite fatigue life (100% or less elongation is below 25% of the ultimate elongation).

With continued reference to FIG. 5, it can be seen that a tire tread 34 is bonded to the outer circumferial surface of the annular wheel assembly 12. Most preferably, the tread 34 is of a rubber or similar materials such as that commonly used for retreading tires. It serves to protect the steel, aluminum, composite or other material from which the non-pneumatic tire and wheel assembly is made. In use, it is easily replaced.

As presented above, the subject non-pneumatic tire and wheel assembly is designed to support loads using tension spoke elements, comprising inner hub rings 24, an annular outer wheel assembly 12 of dual twin rings 12a, 12b, and elastomeric spokes 28 that connect to both in tension mode. The invention generally includes a “wire-spoked wheel,” a hub, a dual wheel rim, and a plurality of elastomeric spokes that transfer torque from the hub to the rim. More specifically, the invention relates to a spoked wheel that uses flexible spokes. The spokes are arranged radially and width-wise tangentially.

The tension spoke system is designed to distribute forces evenly across the wheel. The tension in each spoke varies in vehicle operation, as the ones above the foot print often carry less load with less tension, while those on the upper side of hub are typically under more tension. The angle at which spokes attach to the rim or outer annular wheel assembly 12 (relative to the hub 14) plays a role in distributing forces and ensuring the wheel is durable

The lateral orientation angle at which spokes are placed affects the wheel's resistance to side-to-side forces. Spokes positioned at an angle (known as “crossed” spokes) provide more lateral stiffness, which helps in preventing deformation when the vehicle moving on uneven surfaces or cornering.

The tire and wheel assembly 10 features a dual-wheel outer ring mechanism 12a, 12b with an angular locking system to regulate tension and angular orientation in the elastomeric spokes. This unique indexing mechanism allows the two twin dual wheels to rotate in opposite directions for tire wheel-hub assembly, enabling opposing tangential spoke configurations to achieve precise levels of spoke tension. It is contemplated that this indexing mechanism allows drivers to adjust spoke tension on the go, optimizing traction and mobility for various terrains, especially in off-road, snow, sand, mud or soft soil conditions. This mechanism is suitable for creating an intelligent tire for robotic and driverless vehicles.

The flexible tension spokes are supported by a dual rim wheel that transfers torque from the hub 14 to the rim or outer wheel assembly 12. The dual wheel indexing set-up provides a tangential orientation to the tension spokes. A plurality of spokes may be used on each side of the wheel connected to hub sides. The spokes of wheel assembly 10 and their circumferential and axial lacing pattern determine the static and dynamic stability of the wheel.

The spoked wheel has a first set of spokes under tension on one side of the dual wheel, coupling the rim to a corresponding hub flange with hooks. It has a second set of spokes under tension on the opposite side of the dual wheel, connecting the rim with a corresponding hub flange with hooks. A mix of radial and tangential lacing may also be used to transfer torque from a drive train to the wheel.

The dual wheels 12a, 12b are mounted coaxially equipped with a spoke-tensioning ratchet mechanism, offering at least three distinct angular positions for optimal tension adjustment for a given tire assembly. The tire's structure includes four main components: the dual wheel, tensioned spokes, and a hub ring with hook flanges.

A rubber tread for ground contact is employed. The tension-tension elements or spokes 28 are specifically designed and oriented to maximize performance under higher tension, making the tire capable of supporting loads entirely through tension forces.

When in motion, all spokes operate in a fully tensioned state, effectively distributing the load around the tire circumference. Spokes above the footprint contact zone between the wheel hub and the treaded wheel rim remain in tension to ensure efficient load transfer. The unique top-loading structural design ensures even load distribution across the circumference while maintaining optimal tension in the spokes.

The dual-wheel system provides a predetermined spoke tension with angular orientation, employing an inflated tire like “sky hook” suspension concept. This innovative mechanism supports vehicle operation load with higher tension by the spokes from the upper half of the tire and with lower tension level in spokes in the lower level. These tension elements support various forces and rotational moments generated by a tire as it interacts with the road surface, including longitudinal forces (driving/braking), lateral forces (cornering), and aligning moments, which significantly influence a vehicle's handling and stability. The incorporation of flexible, elastic bungee cord-like structures within the design helps mitigate road vibrations and impact stresses for enhanced performance and durability.

Spokes are the connecting rods between the vehicle hub 14 and the outer wheel assembly or rim 12. Tension spokes serve to transfer the loads between the hub and the rim, which are caused by the weight of the vehicle. Tension spokes can be relatively thin because the load is distributed among multiple spokes.

When the tire and wheel assembly 10 is built, all the spokes start out as loose rubber elements which are gradually tightened by indexing the dual rim system. This is a process referred to as pre-tensioning since one is applying tension even before putting any load on the wheel. The tension must be balanced. Otherwise, the rim of the vehicle may fold to one side and possibly ruin the rim.

Spokes cannot take compression because they are in tension and remain in tension even after the load is applied. Upon loading the tire and wheel assembly 10, bottom spokes will register a distinct change in tension, but that is because they are receiving compressive forces relative to the other spokes. Thus, it can also be said that the hub hangs from the upper spokes.

Kevlar fibres can be used as the spokes. A bungee rubber spoke can be used for durability with highly stretchable braided 100% Dyneema® cover or carbon fiber sleeve. Dyneema® fibers or carbon fiber, is extremely abrasion resistant, while keeping the rubber spoke from being overstretched.

The angle at which spokes intersect the hub and the twin rim wheel affects the tires performance. There are various spoke lacing patterns, with the two most common being radial lacing spokes radiate from the hub to the rim. This pattern is used primarily for lightweight vehicles where the load is minimal. However, it is not as strong under lateral forces.

The crisscrossed lacing (e.g., 3× or 4×) spokes cross each other multiple times between the hub and the rim (3×, 4×, etc.). More crossed spokes (e.g., 3×, 4×) provide better lateral stability and can handle more torque from the engine and the forces from braking and cornering. This crossed spoke pattern is much stronger under lateral loads, as the crossed spokes help resist flexing. The more times the spokes cross, the stronger the wheel, but it can also increase the weight and complexity. The spoke angle varies with the number of spokes and the lacing pattern.

Radial lacing may be used where spokes radiate straight from the hub to the rim. This configuration helps reduce weight and drag, and it is less prone to distortion under braking forces compared to a purely radial-laced rear wheel. However, radial lacing alone cannot handle the same forces as crossed patterns.

The spoke tension needs to be carefully calibrated to ensure that the wheel is both strong and true. The tension in each spoke can be calculated using principles of mechanics, balancing forces within the twin wheel to ensure the wheel remains in a state of equilibrium. The radius of the hub, the spoke length, and the twin wheel diameter play a role in determining the proper spoke tension.

Forces and torque (moment) distribution calculation provide optimal spoke tension and ensure the forces are evenly distributed. The indexing outer rings provide predetermine spoke tension and specific angular tangential orientation in a step-wise manner to evenly increase spoke tension in the wheel. In assembly, it is important to tension the wheel to ensure every spoke is tensioned to the same degree with predetermined orientation.

Spokes are typically made from elastomer core (synthetic or natural rubber, silicone rubber, thermoplastic elastomer, polyurethane) with a highly stretchable sleeve made of braided steel, titanium, aluminum, or carbon fiber. Steel or carbon fiber sleeve is used for its strength, durability, and ability to avoid over stretching. Aluminum sleeve is lighter but less durable under high tension, so it is more adapted for lightweight or specialized wheels.

Depending on the type of vehicle, the spoke count can range from 24 to 40 or more spokes per one side of the wheel. The number of spokes is determined by the load the wheel must handle, as well as the type of vehicle (e.g., road, off-road, or racing).

In high-performance vehicles, the design of the wheel, including the number and arrangement of spokes, is influenced by aerodynamics. Fewer, bladed spokes reduce wind resistance, but at the cost of wheel strength. Spokes with a flat, aerodynamic shape reduce drag.

Composite spokes must withstand much higher forces due to the weight of the vehicle, the forces from engine torque, and the added impact from road conditions. This often results in more spokes, stronger materials, and thicker gauge elastomer core for increased strength. The spokes need to be resistant to stress and fatigue over time. It has been found that keeping spoke elongation below 25% of its maximum rated elongation renders spoke life substantially endless. The vibrations and high torque loads generated by the engine require spokes that are not only strong but also resilient to long-term wear and tear.

Various forces and moments are important for understanding the behavior of a vehicle's tires and its overall handling characteristics. Finite Element Analysis (FEA) can estimate force and moment characteristics of spoke tires accurately and it is helpful for ensuring vehicle safety, performance, and handling. FEA evaluates how spoke tires respond to forces during acceleration, braking, and cornering, directly influencing stability and control. The following data guides spoke tire design, vehicle tuning, and compliance with safety regulations, ensuring reliable performance under various driving conditions. FEA was used to analyze these forces and moments under various tension spokes angular orientation. The data obtained from these studies help in designing safer, more efficient airless tire to optimizing vehicle performance.

In considering the presentation herein and the data below, it should be understood what is intended by a “radial pattern” and a “crisscross lace pattern” of spokes. As the terms imply, a radial pattern is characterized by the spokes extending between the hooks 18a of the hook flange 16a and the hooks 26a of the hook ring 24a on an outside of the tire and wheel assembly 10, and between the hooks 18b of the hook flange 16b and the hooks 26b of the hook ring 24b on an inside of the tire and wheel assembly 10. A crisscross pattern, as the term implies, is characterized by the spokes extending between the hooks 18a of the hook flange 16a and the hooks 26b of the hook ring 24b and also between the hooks 18b of the hook flange 16b and the hooks 26a of the hook ring 24a, thus traversing the wheel assembly both axially and radially.

| | | | | | Tension spokes | | Tension spokes | |
|---|---|---|---|---|---|---|---|---|
| | Tension | | Tension | | arranged in a | | arranged in a | |
| | spoke radial | | spoke radial | | crisscross lace | | crisscross lace | |
| | pattern -12 | | pattern -24 | | pattern with 12 | | pattern with 24 | |
| Type | spokes | | spokes | | spokes | | spokes | |
| Longitudinal | 1000 | lbs | 2500 | lbs | 1400 | lbs | 2700 | lbs |
| (Driving) | | | | | | | | |
| Force (Fₓ): | | | | | | | | |
| Lateral | 1500 | lbs | 1900 | lbs | 1700 | lbs | 1990 | lbs |
| (Cornering) | | | | | | | | |
| Force (Fy): | | | | | | | | |
| Vertical | 2304 | lbs | 4200 | lbs | 2704 | lbs | 4600 | lbs |
| (Load) | | | | | | | | |
| Force (Fz): | | | | | | | | |
| Tire | 100 | lb-ft | 200 | lb-ft | 180 | lb-ft | 250 | lb-ft |
| Moment - | | | | | | | | |
| Aligning | | | | | | | | |
| (Self- | | | | | | | | |
| Aligning) | | | | | | | | |
| Torque | | | | | | | | |
| (Mz): | | | | | | | | |
| Slip angle | 5 | degree | 5 | degree | 5 | degree | 5 | degree |

| | | | | |
|---|---|---|---|---|
| Wheel | Steel & Carbon | Steel & Carbon | Steel & Carbon | Steel & Carbon |
| Material | Fiber | Fiber | Fiber | Fiber |

Thus it can be seen that the various aspects of the invention have been satisfied by the structure presented above. While in accordance with the patent statutes only the best known and preferred embodiment of the invention has been presented and described in detail, the invention is not limited thereto or thereby. For an appreciation of the true scope and breadth of the invention, reference should be made to the following claims.

What is claimed is:

1. A non-pneumatic tire and wheel, comprising:
an outer annular wheel assembly;
an inner hub assembly for attachment to an axle of a vehicle; and
a plurality of elastic spokes in tensioned interconnection between said outer annular wheel assembly and said inner hub assembly.

2. The non-pneumatic tire and wheel according to claim 1, wherein said elastic spokes are in continual tensioned interconnection between said outer annular wheel assembly and said inner hub assembly.

3. The non-pneumatic tire and wheel according to claim 2, wherein said outer annular wheel assembly comprises first and second outer wheel sections that are axially adjustably interconnected by said elastic spokes.

4. The non-pneumatic tire and wheel according to claim 3, wherein said first and second outer wheel sections have respective first and second hook flanges circumferentially thereabout.

5. The non-pneumatic tire and wheel according to claim 4, wherein said inner hub assembly has first and second hub rings thereabout.

6. The non-pneumatic tire and wheel according to claim 5, wherein said elastic spokes are interconnected between hooks of said first and second hook flanges and hooks of said first and second hub rings.

7. The non-pneumatic tire and wheel according to claim 6, wherein said interconnection of said elastic spokes between said hooks of said hook flanges and hub rings is taken from the group of a radial pattern and a crisscross lace pattern.

8. The non-pneumatic tire and wheel according to claim 7, wherein said elastic spokes interconnect said hooks of said first and second hook flanges with said hooks of said first and second hub rings, respectively, in a radial pattern, and hooks of said first and second hook flanges with said hooks of said second and first hub rings, respectively, in a crisscross lace pattern.

9. The non-pneumatic tire and wheel according to claim 7, wherein said first and second outer wheel sections have selectively mating tabs and detents on facing edges thereof, mating engagement of said tabs and detents establishing a tension in said elastic spokes.

10. The non-pneumatic tire and wheel according to claim 9, wherein said mating engagement may be indexed to selectively increase and decrease said tension.

11. The non-pneumatic tire and wheel according to claim 10, wherein said elastic spokes hold said first and second outer wheel sections in engagement and indexing said tension is achieved by axially separating said tabs and detents from engagement, rotating said first and second where sections in opposite directions and reengaging said tabs and detents.

12. The non-pneumatic tire and wheel according to claim 11, wherein said elastic spokes have a characteristic maximum extension of substantially 4 times greater than a maximum extension experienced in operation of the non-pneumatic tire and wheel.

13. The non-pneumatic tire and wheel according to claim 12, wherein said elastic spokes comprise rubber.

14. The non-pneumatic tire and wheel according to claim 13, further comprising a tread bonded to an outer circumferential surface of said outer annular wheel assembly.

15. The non-pneumatic tire and wheel according to claim 14, wherein said tread is a section of retread rubber.

16. A non-pneumatic tire and wheel, comprising:
an outer annular wheel assembly comprising first and second outer wheel sections;
an inner hub assembly for attachment to a vehicle;
said outer annular wheel assembly and inner hub assembly being characterized by axially and radially uniformly positioned connectors; and
a plurality of elastomeric spokes in tensioned engagement between paired connectors of said outer annular wheel assembly and inner hub assembly.

17. The non-pneumatic tire and wheel according to claim 16, wherein said elastomeric spokes extend between said paired connectors in a pattern taken from the group consisting of a radial pattern and a crisscross lace pattern.

18. The non-pneumatic tire and wheel according to claim 17, wherein said first and second outer wheel sections are selectively engageable for indexingly adjusting tension within said elastomeric spokes.

19. The non-pneumatic tire and wheel according to claim 18, wherein extension of said elastomeric spokes in operation is less than 25% of a characteristic maximum extension of said elastomeric spokes.

20. The non-pneumatic tire and wheel according to claim 19, further comprising a cured rubber tread bonded to an outer circumferential surface of said outer annular wheel assembly.
